(19) United States
(12) Patent Application Publication
(10) Pub. No.: US 2008/0044797 A1
(43) Pub. Date: Feb. 21, 2008

(54) Inserts for use with oral appliances

(76) Inventors: Laura Bardach, Boonton, NJ (US); James Geduldig, Boonton, NJ (US); Salvatore Napoli, Florham Park, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/891,649

(22) Filed: Aug. 10, 2007

Related U.S. Application Data
(60) Provisional application No. 60/837,714, filed on Aug. 15, 2006.

(51) Int. Cl. A61C 19/06

(52) U.S. Cl. 433/217.1; 128/861

(57) ABSTRACT

The invention describes a modular inset/insert that may be selectively placed in a user prescribed location in a dental device, the purpose of which is to deliver a beneficial agent in a site specific manner. Insert designs for use with an oral appliance are disclosed. One embodiment insert in particular may include an infrastructure portion, a carrier element, and a beneficial agent. The infrastructure portion may further include a ring and mesh. Preferably, the insert is designed to be received and retained within an inset in the oral appliance. A method of manufacturing an oral appliance capable of receiving a modular inset/insert is also disclosed. Among other steps, the fabrication process includes utilizing a coping and analog for forming at least one inset in the oral appliance during molding.

### CROSS-REFERENCE TO RELATED APPLICATIONS

This application claims the benefit of the filing date of U.S. Provisional Patent Application No. 60/837,714 filed Aug. 15, 2006, the disclosure of which is hereby incorporated herein by reference.

The present application is also related to commonly owned U.S. patent application Ser. No. 10/138,821 (Publication No. 2003/0205234) filed on May 6, 2002, Ser. No. 11/212,220 (Publication No. 2007/0048347) filed on Aug. 26, 2005, and Ser. No. 11/250,210 (Publication No. 2007/0084471) filed on Oct. 14, 2005, the disclosures of which are hereby incorporated herein by reference.

### BACKGROUND OF THE INVENTION

The present invention relates to dental devices and other oral appliances, and more particularly, to cartridge inserts for use with such oral appliances. It is known in the art to utilize, for example, dental devices, such as mouthguards, teething rings, retainers, or the like, to deliver drugs, flavors, or the like. In addition, it is also known to utilize such devices to protect portions of the mouth by providing shock absorption or cover for same. Clearly, as is illustrated by the aforementioned commonly owned applications, many different dental device designs and configurations may be utilized by patients. The present invention, and its many variations, may be utilized in conjunction with most, if not all, of these devices.

For example, mouthguards are typically made from plastics materials such as an ethylene vinyl acetate copolymer (“EVA”). Other devices such as dentoalveolar trays, carriers, and splints may also be made of EVA or other biocompatible plastic material. There are several categories of mouthguards: Mouthguards that are stock pre-molded products and made in a variety of sizes, home or self-moldable products to suit the physical characteristics of the user, or products custom molded by a dentist or other professional to even more specifically suit the characteristics of the user. Regarding physical protection, stock mouthguards are typically the cheapest and least effective in use, while the custom molded and shaped mouthguards are the most expensive and effective in their impact absorbent properties.

Athletes in many sports wear mouthguards for prolonged periods. It is common knowledge that when these athletes engage in strenuous physical activity, they lose and must replace significant amounts of fluids, nutrients, and calories. In order to hydrate themselves and replenish their energy, athletes must drink large quantities of fluids and eat foods that are very often cariogenic. These cariogenic fluids and materials cover the teeth, and when a mouthguard is inserted afterwards, the teeth are acted upon by cariogenic bacteria in an ideal environment shielded from the buffering ability of saliva.

In athletes, factors that serve to diminish salivary flow around the teeth include the general sympathetic tone of the nervous system, dehydration, and shielding of the teeth by a mouthguard. Moreover, the elderly, patients suffering from a variety of autoimmune diseases, patients on a variety of medications, and patients treated in the head region with external beam radiation may also suffer from reduced salivary flow. Whatever the cause, reduced salivary flow greatly increases the incidence of dental caries and periodontal disease.

U.S. Pat. No. 4,920,984 relates to a mouthguard material that may be custom shaped or molded employing a teeth impression cast pressed against softened thermoplastic sheet material that increases in thickness from one end to the other.

Australian patent specification 633269 discloses a mouthguard made from an EVA copolymer having a softening point higher than the normal temperature of an oral cavity but lower than the highest temperature that the oral cavity can endure so that the user may adapt the mouthguard to fit the mouth by biting onto it after it has been heated. The shaping procedure may be repeated if the shape or configuration of the teeth should change.

In FIG. 15 of U.S. Pat. No. 5,082,007 a gel or fluid capsule is contained between the upper and lower portions of a mouthguard. The nature of this gel is not described and appears to serve a mechanical, that is, a shock absorbing function.

It is not only known to employ materials enabling custom or self shaping of mouthguards, it has been suggested that mouthguards use other additives in the material of construction to enhance the characteristics of the material. For example, in U.S. Pat. No. 4,044,762 an athletic mouthguard is formed from a mixture of a plastic resin (e.g., an ethylene vinyl acetate that can be heated and softened to form a custom-fitted impression) and a fluoride compound that protects the wearer's teeth. As an alternative, the reference suggests spraying or otherwise coating the surface of a mouthguard with a fluoride compound. This fluoride compound is gradually delivered while the mouthguard is worn.

In FIGS. 7 and 8 of U.S. Pat. No. 5,323,787 a medicated pad is adhesively secured on the occlusal surface of a mouthpiece to treat the teeth and gums. The pad is saturated with a medicating substance in an intermediate layer of absorbent polymeric or fabric material, and that intermediate layer is overlaid with a non-porous outer layer. The pad can either be replaced or soaked to renew the medication. Specific medications are not discussed, although for other embodiments the mouthpiece is soaked in sterilizing (bactericides) and mouth-refreshing ingredients such as flavorings of the type used in conventional mouthwashes.

German patent specification 4011204 discloses a mouthguard material consisting of an EVA copolymer material, polycaprolactone and colorants and perfumes and PVA (polyvinyl acetate) to reduce the softening point of the resultant mouthguard for ease of manipulation and shaping.

In U.S. Pat. No. 5,395,392 a infant's pacifier has a perforated mouth bulb containing an powder, syrup, or tablet with an agent such as monoclonal antibodies, fluorides, sorbitol, or xylite (xylitol).

Xylitol is a naturally occurring sugar. It is a five-carbon polyalcohol, pentitol, which is widely distributed in nature. Most fruits, berries and plants contain xylitol. Xylitol is also an intermediate of mammalian carbohydrate metabolism. Our bodies produce up to 15 grams of xylitol from other food sources using established energy pathways. Xylitol use is known to reduce tooth decay rates both in high-risk groups (high caries prevalence, poor nutrition, and poor oral hygiene) and in low risk groups (low caries incidence using all current prevention recommendations). Sugar-free chewing gums and candies made with xylitol as the principal sweetener have already received official endorsements from numerous international dental associations. Studies using xylitol as either a sugar substitute or a small dietary addition have demonstrated a dramatic reduction in new tooth decay, along with arrest and even some reversal of existing dental caries. Xylitol provides additional protection that enhances all existing prevention methods. This xylitol effect is long lasting and possibly permanent. Low decay rates persist even years after the trials have been completed.

For the anticariogenic activity of casein phosphopeptides, see U.S. Pat. Nos. 5,015,628; 5,834,427 (method of preparing casein phosphopeptides); and U.S. Pat. No. 5,981,475. For various remineralizing compositions, see U.S. Pat. Nos. 4,348,381; 5,562,895; 5,895,641; and 6,036,944.

For various mouthguards and similar dental devices, see U.S. Pat. Nos. 4,554,154 (plastic that is chewable or usable as dental floss containing remineralizing, immunological, and anti-bacterial agents; e.g. sodium flouride, chlorhexidine and lysozyme); U.S. Pat. No. 5,085,585 (U-shaped applicator is placed over teeth to apply medicaments to teeth and gum pockets); U.S. Pat. No. 5,194,003 (device that fits over teeth releases beneficial agents from a reservoir); U.S. Pat. No. 5,339,832 (composite mouthguard with integral shock-absorbing framework); U.S. Pat. No. 5,365,624 (mouthpieces with cleaning motors or gum cushioning material); and U.S. Pat. No. 6,012,919 (occlusal protector pad in an athlete's dental appliance has an upper layer of EVA and polycaprolactone).

Certain hydrogels, particularly synthetic hydrogels, can act as carriers for drugs and other active agents. These hydrogels allow passage of the agent, in some cases acting as a membrane that allows agent passage. Covalently crosslinked hydrogels can incorporate a drug or other agent during the polymerization step; or the agent can be loaded from a solution. These types of hydrogels tend, however, to be weak when swollen by its water content. With thermoplastic (solvent soluble) hydrogels, an agent or drug can be compounded with the polymer during extrusion or injection molding; or by combining the agent with the polymer solution in a suitable solvent. They can also be obtained either as relatively hard, crystalline blocks, used for structural applications; or as meltable transient clusters that are highly swelling, and useful as emulsifiers, gelling agents, and drug carriers. Various other suppliers of hydrogel exist as well.

For hydrogels with improved stability, see U.S. Pat. No. 5,346,935. See also U.S. Pat. Nos. 5,071,657 (transdermal administration of a medicinal agent dissolved in a nonflowable gel distributed in a microdisperse mode in a crosslinked silicone elastomer); U.S. Pat. No. 5,200,194 (oral osmotic device has a beneficial agent and hydrophilic support fibers inside a semi-permeable membrane); and U.S. Pat. No. 5,252,692 (hydrophilic acrylic copolymers).

See also, U.S. Pat. No. 3,996,934 (bandage using microcapsules to deliver a drug); U.S. Pat. Nos. 5,366,935; 5,286,490 (transdermal patch delivers fluoride medication to treat osteoporosis or periodontal disease); and U.S. Pat. No. 5,925,372 (transdermal delivery system for ethanol soluble drugs).

Aforementioned U.S. Patent Application Publication No. 2003/0205234 (“the '234 application”) teaches a device useful as an intra-oral delivery system capable of delivering an agent to selected surfaces within the oral cavity and/or to deliver one or more agents to different oral surfaces simultaneously. While the invention taught in the '234 application is indeed tremendously useful and very capable of satisfying the long-felt needs to which it is directed, such may be improved upon. For example, there exists a need for an improved insert for use with the device disclosed in the '234 application, as well as other devices previously offered or hereinafter offered.

### SUMMARY OF THE INVENTION

A first aspect of the present invention is an oral appliance, such as a dental device. One embodiment of this first aspect may include a body adapted for use in a human mouth, the body including at least one recessed inset, and at least one cartridge insert adapted for placement in the at least one inset, the cartridge insert having an infrastructure portion and a carrier element.

In other embodiments according to this first aspect, the body may be a U-shaped carrier having at least one channel for embracing an arch of teeth. The U-shaped carrier may be defined by three walls, wherein at least one recessed inset is located on a first wall. Alternatively, at least three recessed insets may be located on the first wall. Still further, at least five recessed insets may be located on the first wall, at least one recessed inset may be located on a first wall and at least one recessed inset may be located on a second wall, or at least one recessed inset may be located on a first wall, at least one recessed inset may be located on a second wall, and at least one recessed inset may be located on a third wall. In certain embodiments, the body may be constructed of EVA.

The infrastructure portion may include a ring and a mesh, and the ring may surround the mesh. In some embodiments, the ring may have a circular cross section, a trapezoidal cross section, or an oval cross section, among other shapes. Preferably, the inset includes undercuts for engaging the ring, and is designed to receive and retain the cartridge insert. The carrier element may also include a beneficial agent, such as Xylitol. In addition, the infrastructure portion may be rigid or semi-rigid. In other embodiments, the cartridge insert may be substantially flat or substantially curved, as well as variations of same. In one preferred embodiment, the body includes at least three insets for receiving at least three cartridge inserts, each cartridge insert infrastructure portion having a ring, a mesh and a beneficial agent.

Another aspect of the present invention is a method of manufacturing a dental device. In accordance with certain embodiments of this second aspect, the method may include the steps of providing a model corresponding to a patient's teeth, and associated dentoalveolar structures, identifying a site on the model, providing a coping having a recessed inset, fastening the coping at or near the site, molding a material around the model and the coping to form the dental device, and removing the dental device from the model.

Other embodiments of this second aspect may further include inserting an analog in the inset of the coping, wherein the inserting step may be performed before the fastening step. The method may also include the step of placing blocking or filler material between the coping and analog, and the model, wherein the fastening step may include utilizing an adhesive, the step of removing the analog subsequent to the molding step, and/or the step of finishing the dental device. The identifying step may include identifying multiple sites, and providing and fastening steps includes the use of multiple copings. Still further, the molding step may include vacuum molding and/or pressure molding. Finally, the method may also include the step of taking an impression of the patient's teeth, and other associated dentoalveolar structures.

Yet another aspect of the present invention is a cartridge insert for an oral appliance, such as a dental device. Certain embodiment cartridge inserts of this aspect include an infrastructure portion and a carrier element connected to the infrastructure portion. In other embodiments, the infrastructure portion may include a ring and a mesh, and the ring may surround the mesh. In still further embodiments, the ring may have a circular cross section, a trapezoidal cross section or an oval cross section, among other shapes. The carrier element may further include a beneficial agent, such as Xylitol. Further, the the infrastructure portion may be rigid or semi-rigid. Depending upon the proposed use and location, the cartridge insert may be substantially flat, substantially curved, or the like. Finally, the cartridge insert may be disposed within an oral appliance or dental device, such as a mouthguard, or the like. Other oral appliances are also contemplated. In one embodiment insert for use with a mouthguard, the infrastructure portion may include a ring and a mesh adapted to be received and retained within an inset formed in the mouthguard. It is to be understood that, rather than a mesh portion, an insert in accordance with the present invention may include any type of matrix suitable for holding a beneficial agent.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a plan view of a dental device showing an open channel of a U-shaped carrier.

FIG. 2 is a plan view showing the reverse side of the dental device of FIG. 1.

FIG. 3 is a plan view of an insert in accordance with the present invention.

FIG. 4 is a cross sectional view of the insert of FIG. 3 taken along line x-x.

FIG. 5 is a cross sectional illustration of the insert shown in FIG. 4 being inserted into an inset.

FIG. 6 is a cross sectional illustration of the insert shown in FIG. 4 inserted into an inset.

FIG. 7 is a cross sectional view of an infrastructure portion of an insert according to another embodiment of the present invention.

FIG. 8 is a cross sectional illustration of an insert employing the infrastructure portion of FIG. 7 being inserted into an inset.

FIG. 9 is a cross sectional illustration of an insert employing the infrastructure portion of FIG. 7 inserted into an inset.

FIG. 10 is a cross sectional view of an infrastructure portion of an insert according to another embodiment of the present invention.

FIG. 11 is a cross sectional illustration of an insert employing the infrastructure portion of FIG. 10 being inserted into an inset.

FIG. 12 is a cross sectional illustration of an insert employing the infrastructure portion of FIG. 10 inserted into an inset.

FIG. 13 is a cross sectional view of an infrastructure portion of an insert according to another embodiment of the present invention.

FIG. 14 is a cross sectional illustration of an insert employing the infrastructure portion of FIG. 13 being inserted into an inset.

FIG. 15 is a cross sectional illustration of an insert employing the infrastructure portion of FIG. 13 inserted into an inset.

FIG. 16 is a cross sectional illustration depicting several different ring configurations for use in accordance with different inserts of the present invention.

FIG. 17 is a front view of an insert in accordance with yet another embodiment of the present invention.

FIG. 18 is a cross sectional view of the insert of FIG. 17 taken along line y-y.

FIG. 19 is a cross sectional view of the insert of FIG. 17 taken along line z-z.

FIG. 20 is an illustration of an empty inset of a dental device in accordance with the present invention.

FIG. 21 is an illustration of the inset depicted in FIG. 20 having the insert depicted in FIGS. 17-19 inserted therein.

FIG. 22 is an illustration of a model of a dental arch.

FIG. 23 is an illustration of the dental arch model of FIG. 22 with a coping and insert analog positioned against a portion of the model.

FIG. 24 is an enlarged illustration of the portion of the model depicted in FIG. 23 having the coping and insert analog positioned against it.

FIG. 25 is another enlarged illustration of the portion of the model depicted in FIG. 23 having the coping and insert analog positioned against it, with boxing material and adhesive placed to block out undercuts between the coping and insert analog and the model surface.

FIG. 26 is an illustration of oral appliance thermoplastic material vacuum-formed onto the dental arch model of FIG. 25.

FIG. 27 is an enlarged illustration of the coping and insert analog portion of the oral appliance depicted in FIG. 26.

FIG. 28 is an illustration of the oral appliance of FIG. 26, with the dental arch model and the insert analog removed therefrom.

FIG. 29 is an enlarged illustration of the inset formed in the model depicted in the oral appliance depicted in FIG. 28.

FIG. 30 is an illustration of the oral appliance of FIG. 29 with an insert cartridge inserted therein.

FIG. 31 is an enlarged illustration of the oral appliance and insert cartridge depicted in FIG. 30.

FIG. 32 is an illustration of the oral appliance of FIG. 30 placed over the dental arch depicted in FIG. 23.

FIG. 33 is an illustration of an oral appliance having an insert analog inserted into an inset, the oral appliance being inserted into a human mouth.

FIG. 34 is an illustration of the oral appliance of FIG. 33 with insert analog removed.

FIG. 35 is an illustration of the oral appliance of FIG. 34 with an insert inserted therein.

### DETAILED DESCRIPTION

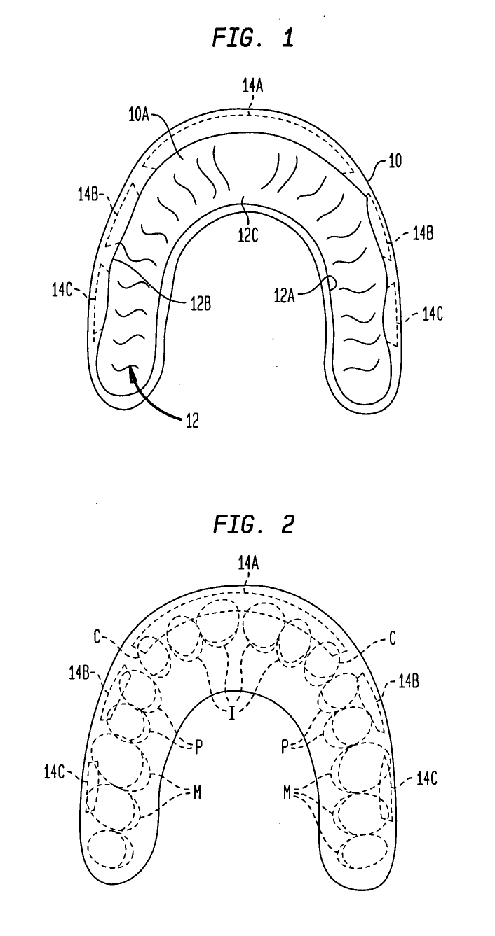

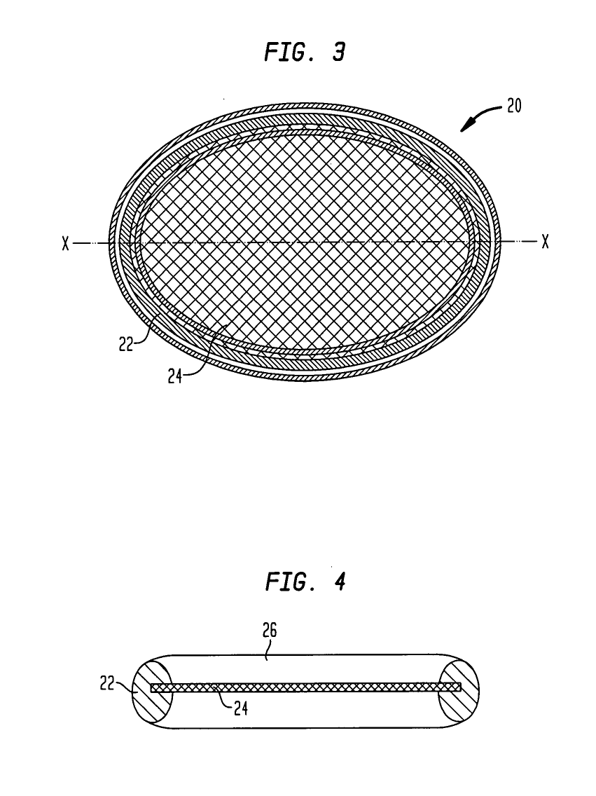

Referring to the drawings wherein like reference numerals refer to like elements, there is shown in the Figures an exemplary dental device 10 (FIGS. 1 and 2) and several embodiment insert cartridges or inserts, the insert depicted in FIGS. 3 and 4 being designated generally by reference numeral 20. Although an exemplary dental device 10 is shown in the Figures and discussed throughout, it is to be understood that the different inserts in accordance with the present invention may be tailored for use in conjunction with many different types of oral appliances. For example, other mouthguard designs similar in nature to that shown in FIGS. 1 and 2 may be utilized, as can teething rings, such as those disclosed in the '234 application, as well as other devices for use in the mouth. In addition, while several different embodiment insert cartridges or inserts (such as insert 20) are disclosed herein, it is to be understood that many different configurations, sizes and designs may be employed in accordance with the present invention. Those of ordinary skill in the art would recognize that such is the case, and that the embodiments discussed and shown in the present application are merely representative of some of the possible inserts according to the present invention.

FIGS. 1 and 2 depict a dental device, carrier, or mouthguard first disclosed in the '234 application. In accordance with the application, the dental device is shown as a U-shaped carrier 10. It is to be understood that the present invention may be utilized in accordance with an oral appliance, although dental device or carrier 10 is depicted in the drawings. Carrier 10 has a channel 12 serving as a recess for receiving an arch of teeth A (Shown in FIG. 2). Carrier 10 can be positioned over the user's upper teeth or the user's lower teeth. If the device is worn on the upper teeth, it may be referred to as a maxillary device. If the device is worn on the lower teeth, it may be referred to as a mandibular device. In this embodiment the device has only a single channel 12 for receiving the arch of teeth A, but other embodiments may have channels on opposite sides for receiving two arches of teeth, such as teeth from the upper and lower jaws. In such an embodiment, the device would preferably employ a clam-shape, with one channel facing the user's nose for receiving the teeth from the upper jaw, and the other channel facing the user's chin for receiving the teeth from the lower jaw.

Channel 12 is formed by an inside wall 12A and an outside wall 12B. Inside wall 12A and outside wall 12B of channel 12 are referred to as a lingual/palatal surface and buccal/labial surface, respectively. An occlusal/incisal surface 12C is located between walls 12A and 12B, and preferably acts to connect inside wall 12A to outside wall 12B. Hereinafter, walls 12A-12C are collectively referred to as walls 12. In a maxillary device, an inner surface of inside wall 12A may touch the user's teeth, gingival and palate, and an outer surface of inside wall 12A may touch the upper (dorsal) surface of the user's tongue. In a mandibular device, the inner surface of inside wall 12A may touch the teeth, gingival and lingual surface of the dentoalveolar process, and the outer surface of inside wall 12A may touch the under-surface (ventral) of the tongue. In both a maxillary and mandibular device, an inner surface of outside wall 12B may touch the user's gingival and teeth, and an outer surface of outside wall 12B may touch the user's cheeks and/or lips.

The intended material for carrier 10 may, for various embodiments, be any such material as is currently used in therapeutic intra-oral carriers or sports mouthguards. Mouthguards are typically made from plastic materials such as an ethylene vinyl acetate copolymer (EVA). Additives may be added to the EVA itself to provide special chemical or physical properties for different application. In some embodiments of this device, flavoring, and aromatic agents may be added to the polymer. Colorants, perfumes, and softening agents may be added as well. For example, German patent 4011204 discloses a mouthguard material consisting of an EVA copolymer material, polycaprolactone, colorants, perfumes, and polyvinyl acetate (PVA). The softening point of the resultant mouthguard is reduced for ease of manipulation and shaping.

Carrier 10 also preferably has one or more insets 14 arranged to maximize effective administration of a beneficial agent. Insets 14 may be placed on the inner or outer surfaces of the walls 12 of the maxillary or mandibular carrier 10. Inset 14A is a recess in the inner surface of outside wall 12B, located in front of four incisors I and two canines C of arch A (this combination being referred to as the anterior six teeth). A pair of back insets 14B is also included in the inner surface of outside wall 12B, each in front of a pair of premolars P. Another pair of back insets 14C is also included in the inner surface of outside wall 12B, each in front of a pair of molars M (or in some cases all molars). Each inset 14 is preferably adapted to receive an insert in accordance with the present invention. The particular connection means between insets 14 and the various inserts described herein will be discussed more fully below, but it is to be understood that other means may be employed depending upon the particular insert construction being utilized. Once again, while carrier 10 is designed as a mouthguard, and insets 14 are designed for use with such, other patterns for insets 14 are contemplated, as are for carrier 10.

As is mentioned above, there are generally three categories of mouthguard designs: (1) Mouthguards that are stock pre-molded products and made in a variety of sizes; (2) Home or self-moldable to suit the physical characteristics of the user; and (3) Custom molded by a dentist or other professional to suit the characteristics of the user. Typically, custom-made mouthguards are fabricated by a vacuum-forming or pressure-forming process whereby two or three laminar sheets of EVA are heat adapted to a mold. The number of lamina used and the thickness at any point will be determined by the intended use of the mouthguard/carrier, i.e. for therapeutics delivery only; or for delivery of therapeutics while worn as a protective mouthguard in sports related activities. The present invention will be mostly discussed with regard to such custom-made mouthguards, but it is to be understood that the insert cartridges or inserts according to the present invention may be utilized in connection with either of the other two types of mouthguard designs.

FIGS. 3 and 4 depict one embodiment insert cartridge or insert 20 according to the present invention. As is shown in the figures, each insert 20 preferably includes a infrastructure portion made up of a rigid or semi-rigid ring 22 and a mesh 24, a carrier element 26, and a beneficial agent (not shown). The infrastructure portion preferably provides sufficient structural integrity to insert 20 such that the other elements may be retained within the insert. In addition, the infrastructure portion also preferably allows the insert to be securely fastened into an inset (such as insets 14) provided in a device (such as device 10). This will be discussed more fully below. With regard to the elements of the infrastructure portion, it is note that ring 22 is preferably constructed of materials capable of providing the aforementioned rigid or semi-rigid characteristics. Suitable materials may include rubber or polymer materials like EVA, among others.

Mesh 24 is preferably constructed so as to provide a backbone for carrier element 26. Because of the dissolvable nature of carrier element 26, mesh 24 is preferably designed so as to form a mesh having a plurality of relatively large apertures formed therein. This may allow for carrier element 26 to be locked in place, while also allowing for the complete dissolving of same. Once carrier element 26 is fully dissolved, mesh 24 preferably provides support to the remaining portions of insert 20 in order to hold such in place within device 10. Of course, many different mesh designs may be utilized, and mesh 24 may be constructed of many different materials. Most notably, mesh 24 should be constructed so as to properly cooperate with carrier element 26. Thus, the materials used in element 26 may dictate the material utilized in constructing mesh 24. It is noted that any suitable matrix may be provided, in addition to or in place of, mesh 24, in order to carry a beneficial agent.

Carrier element 26 is preferably designed to carry and deliver the beneficial agent (not shown). Most preferably, carrier element 26 is designed so as to allow the desired delivery of the beneficial agent over a proscribed period of time and at a proscribed delivery quantity and rate. In certain embodiments, carrier element 26 may be a hydrogel, gelatin or starch that is water-soluble or water-stable such that it will retain a beneficial agent and dissolve and release the beneficial agent and/or retain its molecular configuration and allow the elution of the beneficial agent. Some suitable hydrogels are discussed above in the Background of the Invention section of the present application. Clearly, other hydrogels or other suitable materials may also be employed, as would be apparent to those of ordinary skill in the art.

The beneficial agent (not shown) may be any substance that may be intended for local topical, transmucosal and/or enteric delivery. Preferably, as is mentioned above, the beneficial agent may be diffused within carrier element 26, or alternatively, within an arbitrary diagnostic vehicle (e.g., salivary chemistry agent or culture medium) that is held in place by the infrastructure portion of insert 10. The beneficial agent may be one or more of any numbers of suitable materials or formulations. For example, the beneficial agent may be the above-discussed Xylitol. Other beneficial agents may be one or more of those disclosed in the '234 application, the disclosure of which has been incorporated herein by reference above, or any other suitable material or formulation as recognized by those of ordinary skill in the art.

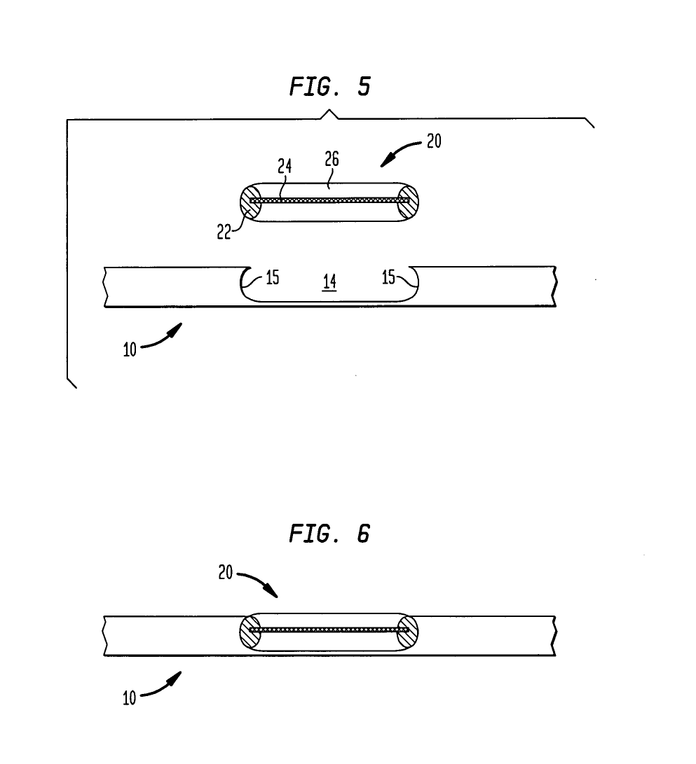

FIGS. 5 and 6 illustrate the placement of insert 20 into an inset 14 of carrier 10. Essentially, the placement of insert 20 into an inset 14 simply requires that the insert be snapped into place. As is shown in FIGS. 5 and 6, inset 14 preferably includes undercuts 15 which are shaped in a complimentary fashion with respect to ring 22 of insert 20. For example, as is best shown in FIG. 5, undercuts 15 include a rounded shape to cooperate with and lock into a place a like rounded ring 22. Ultimately, a portion of undercuts 15 overhangs ring 22 when in the fully inserted position (FIG. 6) thereby providing the locking. The rigid or semi-rigid nature of the infrastructure portion of insert 20 preferably allows for the snapping of the insert into inset 14 and preferably causes the insert to remain therein. As will be discussed more fully below, other embodiment inserts 20 employ different configurations designed to cooperate with different insets 14.

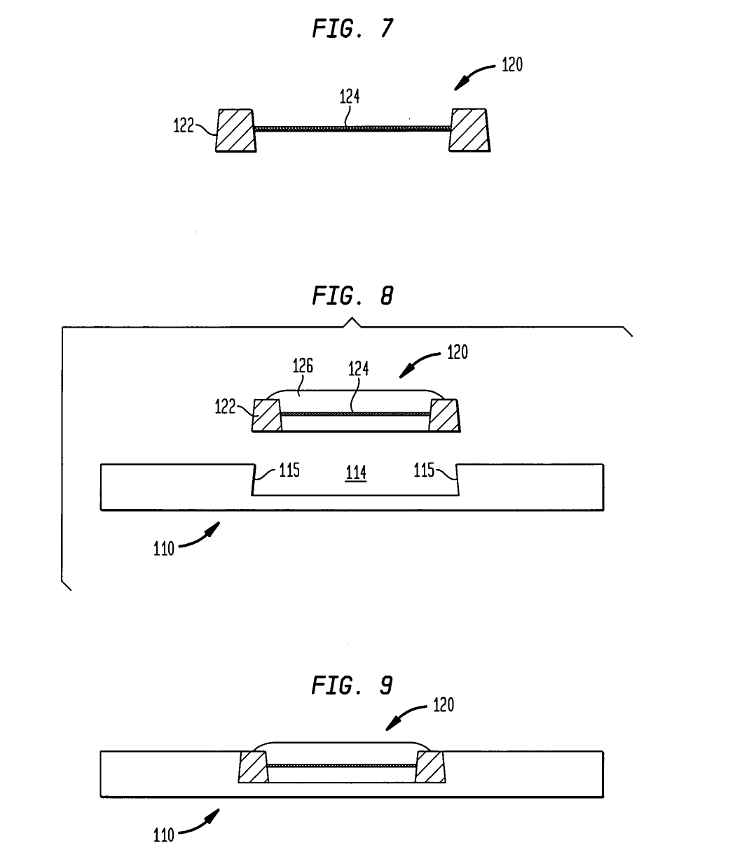

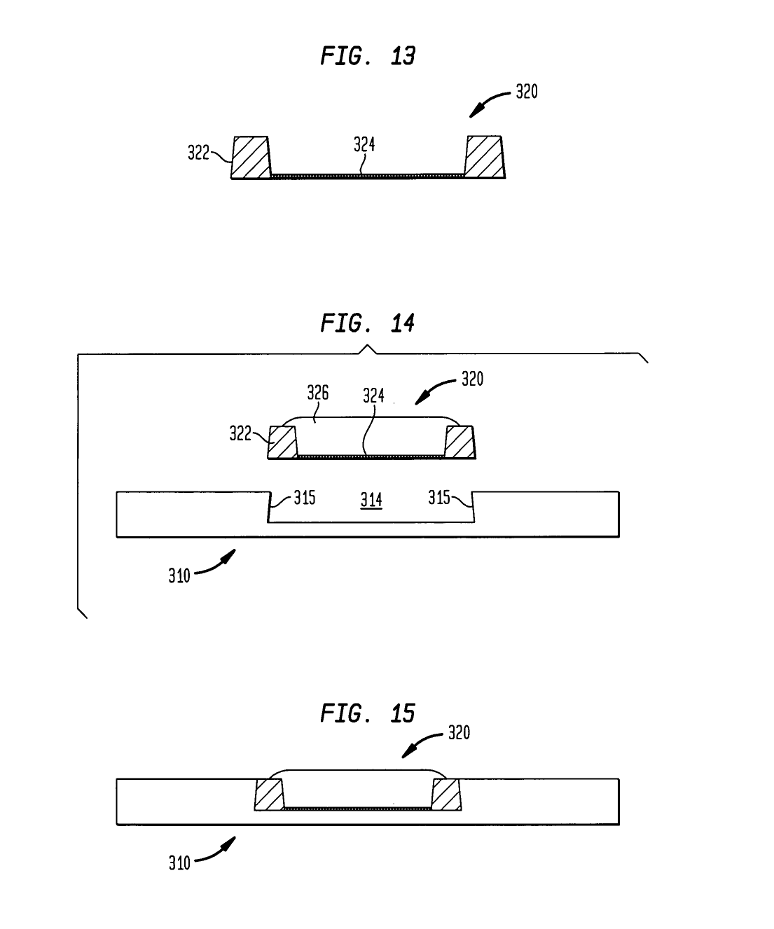

FIGS. 7-16 depict differently configured inserts for insertion into differently configured insets. Throughout these figures, like reference numerals are utilized for like elements to that of insert 20, but within different 100-series of numbers. For example, FIG. 7 depicts the infrastructure portion of another embodiment insert 120, having a ring 122 and a mesh 124. As is best shown in FIG. 7, ring 122 of insert 120 employs a trapezoidal cross section, as opposed to the rounded cross section of ring 22 of insert 20. Likewise, inset 114 of device 110 includes undercuts 115 (best shown in FIG. 8) designed to allow insertion of insert 120, while retaining same thereafter. FIG. 9 depicts the fully assembled state of device 110, with insert 120 disposed in inset 114.

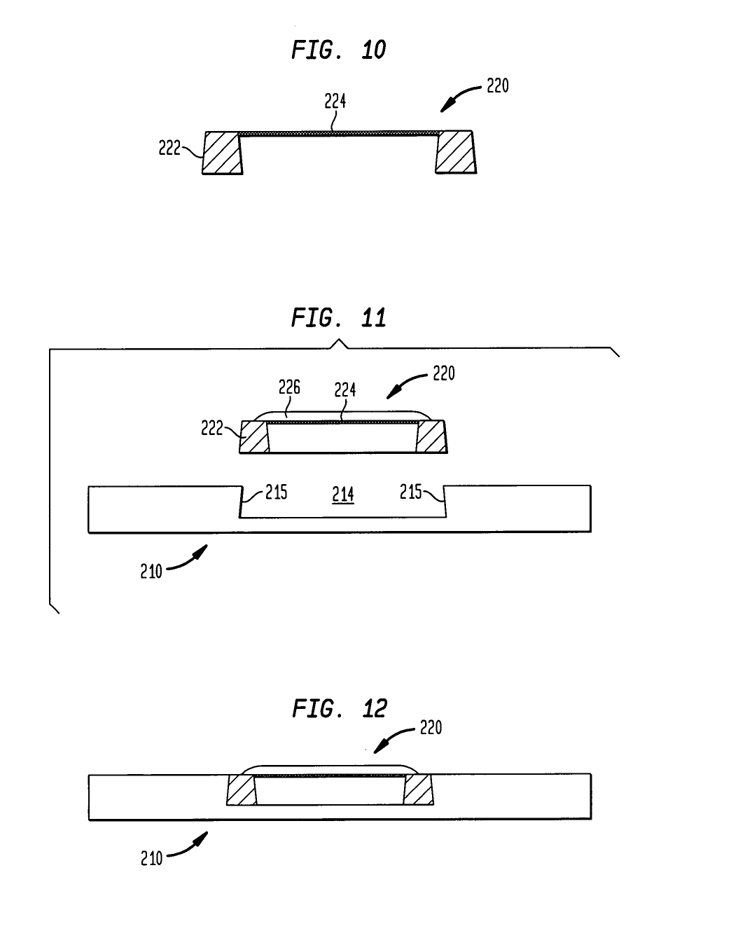

FIGS. 10-15 depict two additional embodiment devices 210 and 310 and inserts 220 and 320. While rings 222 and 322 of inserts 220 and 320, and undercuts 215 and 315 of insets 214 and 314 are strikingly similar to that of insert 120 and inset 114, inserts 220 and 320 differ in the placement of meshes 224 and 324 with respect to rings 222 and 322. Where mesh 124 of insert 120 is vertically disposed approximately halfway between the top and bottom of ring 122, mesh 224 is vertically disposed at or near the top of ring 222 and mesh 324 is vertically disposed at or near the bottom of ring 322. These different configurations preferably provide for different cooperations with carrier elements 226 and 326, and may promote a different diffusion of any beneficial agent included with the carrier elements. In addition, varying the vertical disposition of meshes 224 and 324 may allow for more or less carrier element 226 and 326 to be included in inserts 220 and 320. Aside from the different vertical height of meshes 224 and 324, inserts 220 and 320 cooperate with devices 210 and 310 in substantially the same manner as both insert 20 and 120 do with devices 10 and 110, respectively.

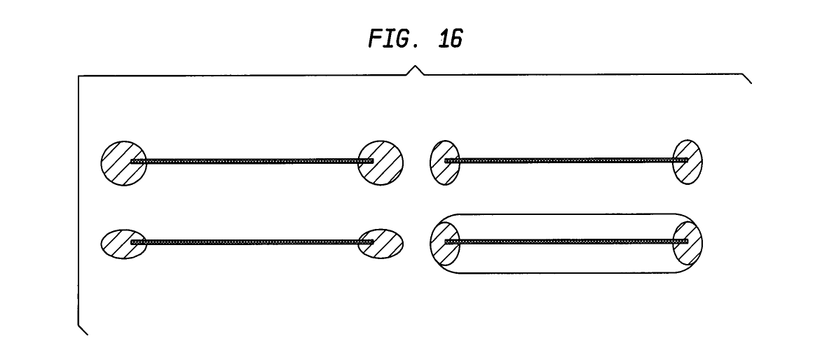

FIG. 16 depicts several different inserts according to the present invention, employing different ring cross sections. For example, a ring having a rounded cross section (similar to that of ring 22), a ring having a horizontally disposed oval cross section and a ring having a vertically disposed oval cross section are all shown in FIG. 16. Of course, other designs are contemplated, such as the aforementioned trapezoidal cross section, and others apparent to those of ordinary skill in the art. Clearly, insets capable of receiving and retaining the inserts depicted in FIG. 16 should include undercuts suitably shaped to provide the proper cooperation. For example, a horizontally deeper undercut would need to be provided to receive and retain the horizontally disposed oval cross section design depicted in FIG. 16. It is to be understood that any of the cross sectional designs may be included in conjunction with any of the other embodiment inserts. For instance, the mesh of the respective insert may be disposed at any vertical height with respect to any of the cross sectioned rings. Thus, many different combinations may be created.

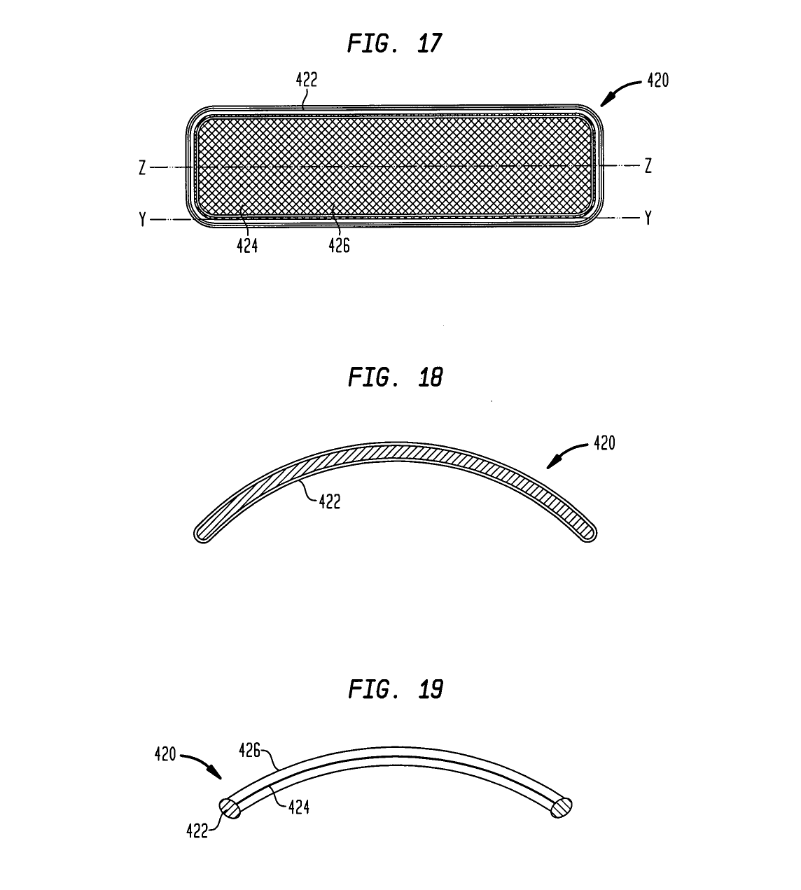

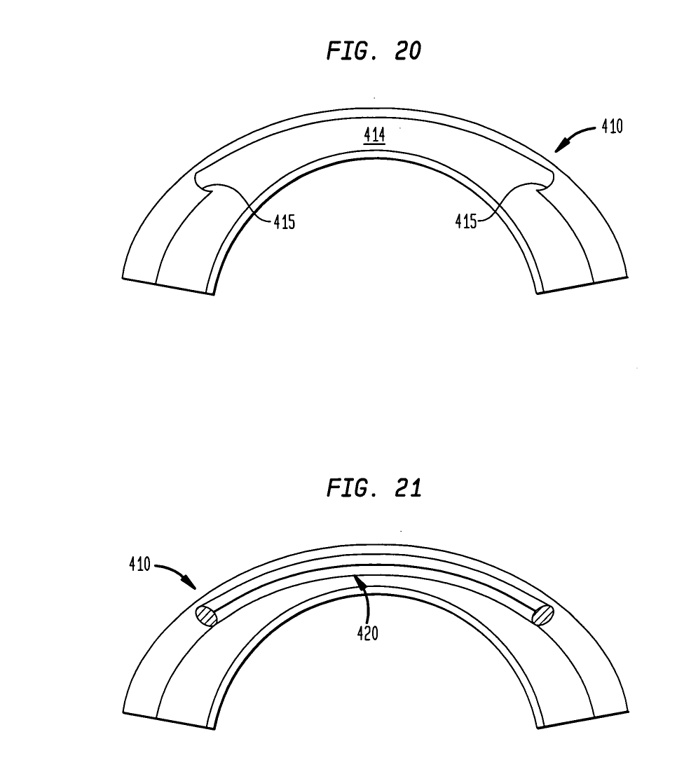

FIGS. 17-21 depict yet another embodiment insert 420 in accordance with the present invention. As is shown in FIG. 17, insert 420 has a general rectangular front face for contacting a portion of the user's mouth. However, as is depicted in FIGS. 18 and 19, insert 420 is also curved to engage, for example, the front teeth of a user. Thus, insert 420 is designed to engage a varying surface of the user's mouth. This is made more apparent by the illustrations of FIGS. 20 and 21, in which, insert 420 is inserted into an inset in a mouthguard 410. Although only a portion of device 410 is shown in those figures, it is clear that such is similar to the embodiment depicted in FIGS. 1 and 2. More particularly, inset 414 is similar to inset 14A in the inner surface of outside wall 12B of device 10, in that it is located in front of the anterior six teeth. While this embodiment is just one of many possible embodiment device and insert combinations according to the present invention, it is important to note that inserts may be varied in all three dimensions in order to tailor to a specific use. Given the varying structures and surfaces present in the human mouth, this is a very important aspect of the present invention.

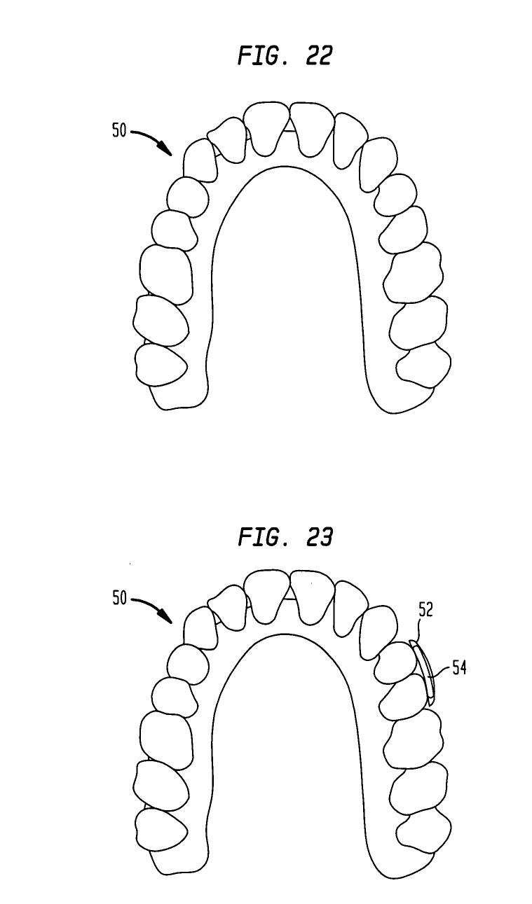

The process of manufacturing a dental device (such as device 10) for use with an insert according to the present invention (such as insert 20) will now be described. As mentioned above, the present invention may be utilized in conjunction with, for instance, custom-made mouthguards. In making a custom mold, the dental professional would first take an impression of the patient's dental arch for which the oral appliance or device is to be made. This impression is then cast in any acceptable casting material such as plaster or stone in order to create a cast dental model, such as model 50 of FIG. 22. This essentially provides a very accurate model of the patient's teeth, and associated dentoalveolar structures, and allows for the majority of the manufacturing process to be done without the patient present.

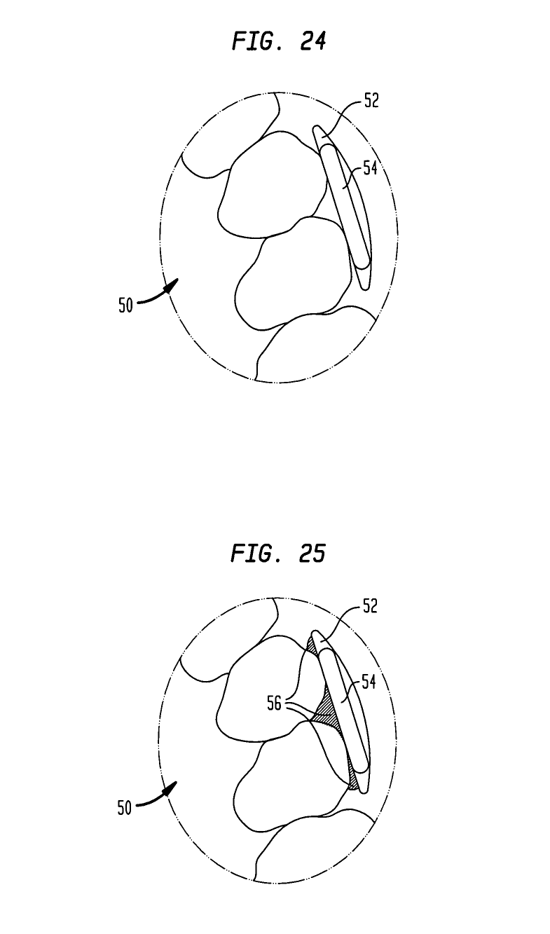

Once the dental professional has model 50, he or she preferably then determines the specific site at which to locate an insert cartridge or insert (e.g., insert 20). This step is depicted in FIG. 23, in which a coping 52 and insert analog 54 have been placed in an area generally corresponding to the area defined by inset 14B in FIG. 2. Of course other areas may be targeted depending upon the ultimate use for device 10. FIG. 24 more clearly depicts the placement of coping 52 and analog 54 with respect to model 50. It is noted that coping 52 and analog 54 are employed for specific reasons in the fabrication of device 10. First, coping 52 is designed to ultimately define inset 14 and undercuts 15. Coping is preferably constructed of a material that will bond with common oral appliance materials, such as EVA. In addition, coping 52 may include surfaces having a pattern (such as additional undercuts) into which the oral appliance material may flow during fabrication, thereby mechanically locking coping 52 into device 10. Furthermore, coping 52 is designed so as to create a smooth and continuous contour in device 10. For example, coping 52 (as shown) includes a convex outer surface which causes the creation of a like surface during the remainder of the manufacturing steps, as will be discussed below. Should coping 52 not employ such a surface, device 10 may ultimately include surfaces that are uncomfortable to the end user. In addition, coping 52 should be shaped according to the desired inset. For example, a coping 52 used in making the inset shown in FIGS. 20 and 21 would be curved. Second, analog 54 is employed during the fabrication process, so as to prevent damage to inset 14 or the like. Analog 54 is essentially a blank constructed so as to withstand the various fabrication steps that will be discussed below.

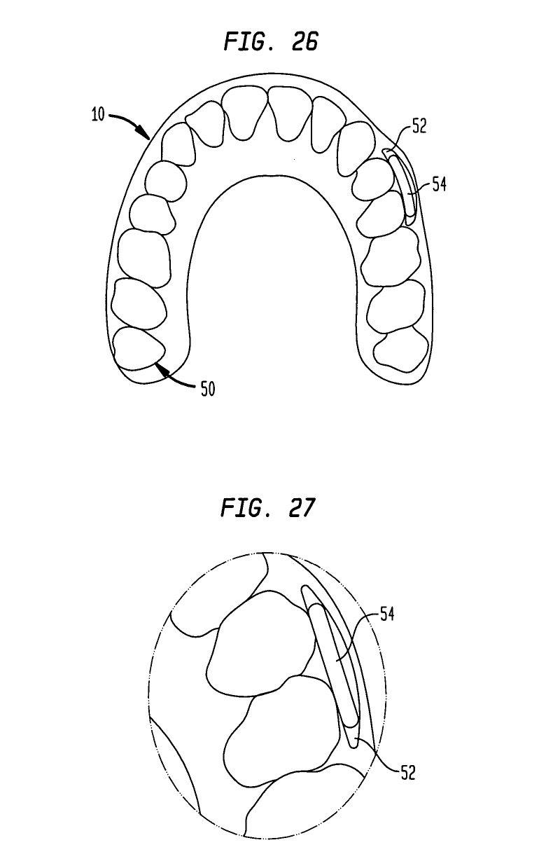

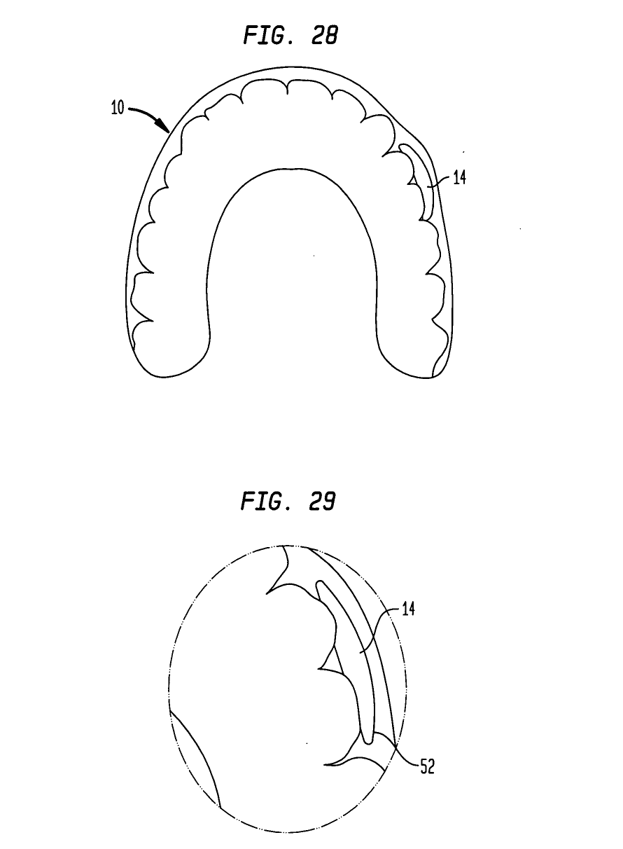

Once the dental professional determines the specific site at which to locate insert 10 or the like, coping 52 and analog 54 are preferably fastened to model 50. As shown in FIG. 25, this fastening step may be accomplished through the use of an adhesive or other suitable means. Blocking or filler material 56 (FIG. 25) is also preferably placed into the voids between coping 52 and analog 54, and the corresponding surfaces of model 50 so that during the vacuum or pressure molding of device 10, device material does not flow into such voids. Thereafter, the shell of device 10 may be formed through such processes as vacuum-forming or pressure-forming whereby two or three laminar sheets of EVA are heat adapted to mold 50. Of course, other suitable processes may be utilized as are known in the art. A device 10 is shown disposed over model 50 with coping 52 now integrally formed with the device and analog 54 disposed therein in FIGS. 26 and 27.

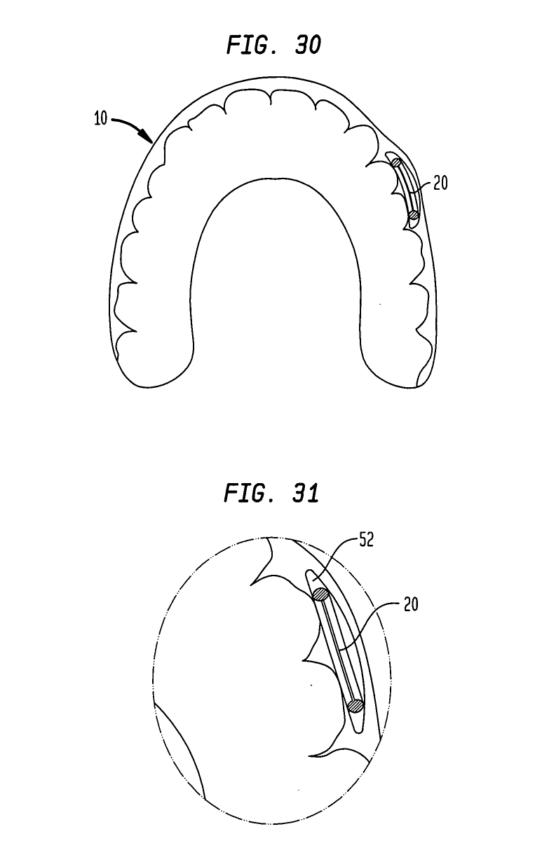

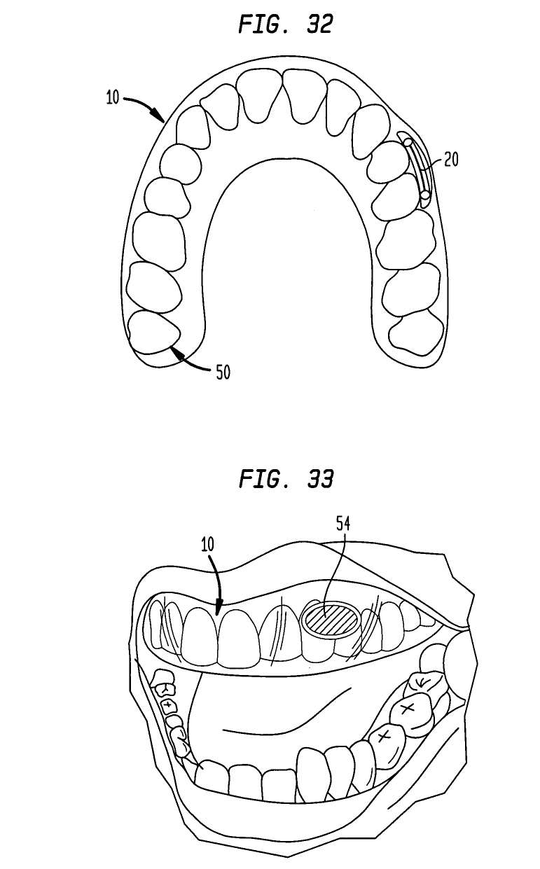

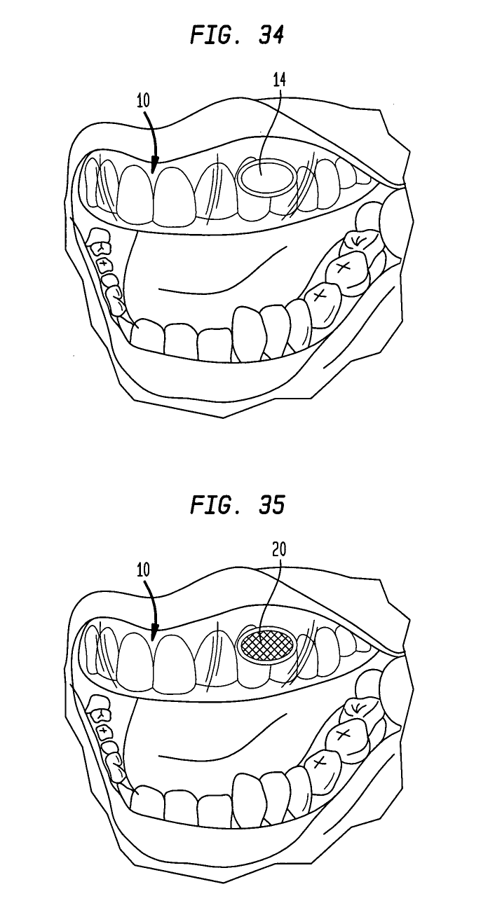

Subsequent to the formation of device 10, analog 54 may be removed, thereby leaving a device having an inset 14. This is best shown in FIGS. 28 and 29. Finally, an insert (such as insert 10) in accordance with the present invention may be disposed within inset 14 and the device put to use. FIGS. 30 and 31 show device 10 with insert 20 disposed within inset 14, and FIG. 32 shows this same apparatus in relation to model 50. Likewise, FIGS. 33-35 depict device 10 in conjunction with a human mouth. Specifically, FIG. 33 depicts device 10 with analog 54 disposed therein, FIG. 34 depicts device 10 with an open inset 14, and FIG. 35 depicts device 10 with insert 20 disposed within inset 14. It is to be understood that the above discussed manufacturing steps may be utilized to form more than one inset 14 for the insertion of more than one insert 20 in device 10. Essentially, the creation of more than one inset 14 would merely require employing more than one coping 52 and analog 54 during the fabrication, as coping 52 essentially becomes inset 14. In addition, it is to be understood that coping 52 may be designed so as to ultimately define an inset capable of receiving and retaining any insert in accordance with the present invention. Finally, more, less or different methods steps may be employed in order to achieve the same or similar finished product device 10. Those of ordinary skill in the art would readily recognize where such variations in the method of manufacture may lie.

The inserts according to the present invention may be utilized in conjunction with the devices and methods disclosed in the '234 application. Essentially, the inserts of the present invention are designed for use in treating areas within the mouth of human being, but could be designed for uses in other portions of the human body or in connection with the treatment of other animals. Oral appliances or devices that may employ any of the inserts disclosed herein may include any device placed into the oral cavity, intended for the prolonged retention by way of binding, mechanical attachment or adhesion to an intraoral surface, feature or structure. For example, such appliances may be dentures (partial/complete) or other prosthetic devices intended to replace teeth, bruxism devices, sleep apnea devices, bleaching trays, mouthguards (including and other than those disclosed herein), temporomandicular joint disease management devices, occlusal equilibration or “bite-opening” devices, maxillary obturators, orthodontic appliances and retainers, post-surgical prostheses, among others. In addition, custom or semi-custom or oral appliances for treatment of dental/periodontal disease, for treatment of oral mucosal disease, for behavioral modification, for infective agent culturing, for cytologival testing, for treatment of medical disease, for adjunctive treatment of obesity, for diagnosis of oral/dental/periodontal disease, for application of flavor, for application of nutrients, for application of hydration, or for salivary diagnosis of medical disease may utilize the inserts disclosed herein. Of course, other uses apparent to those of ordinary skill in the art are also captured by the present application.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An oral appliance comprising:
a body adapted for use in a human mouth, the body including at least one recessed inset; and
at least one cartridge insert adapted for placement in the at least one inset, the cartridge insert having an infrastructure portion and a carrier element.

2. The oral appliance according to claim 1, wherein the body is a U-shaped carrier having at least one channel for embracing an arch of teeth.

3. The oral appliance according to claim 2, wherein the U-shaped carrier is defined by three walls.

4. The oral appliance according to claim 3, wherein at least one recessed inset is located on a first wall.

5. The oral appliance according to claim 4, wherein at least three recessed insets are located on the first wall.

6. The oral appliance according to claim 4, wherein at least five recessed insets are located on the first wall.

7. The oral appliance according to claim 3, wherein at least one recessed inset is located on a first wall and at least one recessed inset is located on a second wall.

8. The oral appliance according to claim 3, wherein at least one recessed inset is located on a first wall, at least one recessed inset is located on a second wall, and at least one recessed inset is located on a third wall.

9. The oral appliance according to claim 1, wherein the infrastructure portion includes a ring and a mesh.

10. The oral appliance according to claim 9, wherein the ring surrounds the mesh.

11. The oral appliance according to claim 10, wherein the ring has a circular cross section.

12. The oral appliance according to claim 10, wherein the ring has a trapezoidal cross section.

13. The oral appliance according to claim 10, wherein the ring has an oval cross section.

14. The oral appliance according to claim 9, wherein the inset includes undercuts for engaging the ring.

15. The oral appliance according to claim 14, wherein the inset is designed to receive and retain the cartridge insert.

16. The oral appliance according to claim 1, wherein the carrier element includes a beneficial agent.

17. The oral appliance according to claim 16, wherein the beneficial agent is Xylitol.

18. The oral appliance according to claim 1, wherein the infrastructure portion is semi-rigid.

19. The oral appliance according to claim 1, wherein the cartridge insert is substantially flat.

20. The oral appliance according to claim 1, wherein the cartridge insert is substantially curved.

21. The oral appliance according to claim 1, wherein the body includes at least three insets for receiving at least three cartridge inserts, each cartridge insert infrastructure portion having a ring, a mesh and a beneficial agent.

22. A method of manufacturing a dental device comprising the steps of:
providing a model corresponding to a patient's teeth;
identifying a site on the model;
providing a coping having a recessed inset;
fastening the coping at or near the site;
molding a material around the model and the coping to form the dental device; and
removing the dental device from the model.

23. A cartridge insert for an oral appliance comprising:
an infrastructure portion;
and a carrier element connected to the infrastructure portion.

24. The cartridge insert according to claim 23, wherein the infrastructure portion includes a ring and a mesh.

25. The cartridge insert according to claim 24, wherein the ring surrounds the mesh.

26. The cartridge insert according to claim 25, wherein the ring has a circular cross section.

27. The cartridge insert according to claim 25, wherein the ring has a trapezoidal cross section.

28. The cartridge insert according to claim 25, wherein the ring has an oval cross section.

29. The cartridge insert according to claim 23, wherein the carrier element includes a beneficial agent.

30. The cartridge insert according to claim 29, wherein the beneficial agent is Xylitol.

31. The cartridge insert according to claim 23, wherein the infrastructure portion is semi-rigid.

32. The cartridge insert according to claim 23, wherein the cartridge insert is substantially flat.

33. The cartridge insert according to claim 23, wherein the cartridge insert is substantially curved.
